(19) United States
(12) Patent Application Publication
(10) Pub. No.: US 2017/0345330 A1
(43) Pub. Date: Nov. 30, 2017

(54) ARTS-BASED LIFE COACHING METHOD

(71) Applicant: Yvette Ramos-Volz, Andover, NJ (US)

(72) Inventor: Yvette Ramos-Volz, Andover, NJ (US)

(21) Appl. No.: 15/163,118

(22) Filed: May 24, 2016

(51) Int. Cl. G09B 19/00

(52) U.S. Cl. CPC G09B 19/00

(57) ABSTRACT

An Arts-Based Coaching (ABC) method guides each of a group of one or more participants through a personal transition process in response to a life challenge, such as a new opportunity, a new job, a trip, loss of a family member, or change of marital status. The process comprises four stages of change—identify, deconstruct, rebuild and reinforce—which each participant is coached to understand and express through the creation of a patterned artwork in four corresponding stages.

### FIELD OF INVENTION

The present invention relates to the field of Arts-Based Learning, and more particularly to the field of Arts-Based Coaching, as a process of navigating life changes and successfully internalizing change, identifying triggers of behavior and defining positive outcomes.

### BACKGROUND OF THE INVENTION

In a person's life, change can be seen as positive or negative depending on the nature of the event, such as a new opportunity, a trip, the loss of a family member, a new job, or a change in marital status, to name a few. Anything that threatens the status quo can appear daunting. During these times of change, individuals tend to fall back on familiar ways of doing things and follow old patterns that result in the same outcomes.

In the workplace—where individuals spend the majority of their day—the methods normally used to address change typically rely on traditional ways of systemic linear thinking, often focused on the bottom line and getting things done faster to meet unrealistic, immeasurable, deadlines and outcomes that do not yield transformative results.

Without bringing people along in the change, it will not endure. Individual change requires addressing human emotions, feelings and behavior toward change. Failure to do so leads to a loss of motivation, productivity and human capital itself in the form of absenteeism, turnover and disability. Leaders, educators and practitioners can facilitate this process through creative and innovative coaching interventions. If total personal transformative change is to occur in this rapidly changing world, the focus must shift to new ways of thinking and doing, in the interest of changing individual's perceptions, affecting changes in behavior, emotions and feelings. In order for individuals to successfully traverse change transformations they first need to understand their own personal transitions.

Arts-Based Learning is an established field, although not universally deployed, that has been used as an alternative to traditional learning methods in education, business and health-care. Its focus is on new ways of learning, developing skills and competencies and new ways of creating and innovating through the creative process of primarily group-based arts: visual, performing and literary. It can also be used as a powerful coaching intervention for guiding individuals through personal change transitions, in life and in organizations. If individuals can be coached through change transformations—in a safe space where they can use the arts to see, express and feel their way through what they are experiencing—then they can begin to identify their challenges, deconstruct old patterns, rebuild new opportunities and reinforce a new reality. Ultimately, this new behavior can organically spread to groups, communities and organizations. The present invention stresses the importance of addressing emotions and feelings in change transitions, and clarifies how individuals experience change.

Art thrives outside of one's comfort zone. It relishes in ambiguity, chaos and what is different. It engages the whole person by eliciting the imagination and intuition, through expression, pre-linguistic and often subconscious forms of expression that engage a learner's imaginal and intuitive process, emotions, empathy and felt resonance. The focus is in what emerges, not in what is designed or intended. Its fruit is in the journey not the destination.

The present invention builds on Art-Based Learning to use Arts-Based Coaching (ABC) as a powerful tool for helping individuals gain deeper insight into their own personal challenges and begin to see the possibilities of building a new way forward.

### SUMMARY OF THE INVENTION

The role of the coach as facilitator is critical. Coaches create a safe space and develop an environment of trust and expansion by listening, remaining present, creating room for experimentation and allowing time for individuals to develop a new way of doing and behaving, eliciting and providing feedback throughout the process, and evaluating final outcomes through guided instruction, for moving in new directions.

A coach first needs to be open to the idea that there is value in facilitating a change process via the arts and that there is power in tapping into creativity. Coaches must view the arts and creative pursuits as productive ways to get people out of their heads, feel their ways through challenges and understand the true meaning of their experiences in ways that ultimately help them move forward.

A coach must also set the stage for this experience by inviting participants to come on this journey with a formal invitation. This can be accomplished via a survey or questionnaire that assesses the current state the individual is in and establishes a venue for this facilitation to take place. The survey also provides an itinerary detailing the events that will take place throughout with an intended outcome. Maintaining a schedule of daily activities ensures each stage of the process is addressed and attention is given to the amount of space required for individuals to process the emotions and feelings that may surface at each stage, given their current state of mind.

Ultimately, the coach methodically follows a model that walks individuals through the change process. This process comprises four stages of change in the Arts-Based Coaching model—identify, deconstruct, rebuild and reinforce. In this model, the coach begins to develop a relationship with individuals and creates a safe space for discovery and reflection. This space allows individuals to envision and manifest an alternative to the status quo by providing a direction to move in at each step of the journey.

This model is an alternative method to traditional change interventions for how individuals experience planned and unplanned change, harnessing the basis of Arts-Based Learning and building on the theories of individual change transition and personhood, it supports an individual's experience of new ways of looking at challenging situations, exercising their inner voice through self-reflection and expression—often lost in the day-to-day routine—by the process of making a patterned artwork, such as a leaded stained glass window.

Using this method, not until a person deconstructs something and builds it back up again can they see the value in the transition. In practice, when constructing a leaded stained glass window, you first start with an image of interconnected pieces in the form of a pattern. Then the pattern is deconstructed into smaller pieces. These pieces are used to construct glass replicas. When the glass is cut, the edges are still sharp and they need to be smoothed out and rounded off in order for each new piece to make a nicely fitted connection with its adjacent pieces, similar to how individuals need to smooth out their own edges before they can successfully traverse change and interconnect with the world around them. These glass pieces are then connected with strips of lead and the intersecting joints are soldered together for stability and a new picture emerges. The new image is then reinforced with cement for sustainability and protection from external elements. This process is similar to how individuals, too, must deconstruct old patterns of behavior to ultimately rebuild anew.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1 is a schematic diagram of the four-step Arts-Based Life Coaching Method according to the preferred embodiment of the present invention; and

FIG. 2 is a diagram of an exemplary stained-glass template used in the four-step Arts-Based Life Coaching Method according to the preferred embodiment of the present invention.

### DETAILED DESCRIPTION OF THE PREFERRED EMBODIMENT

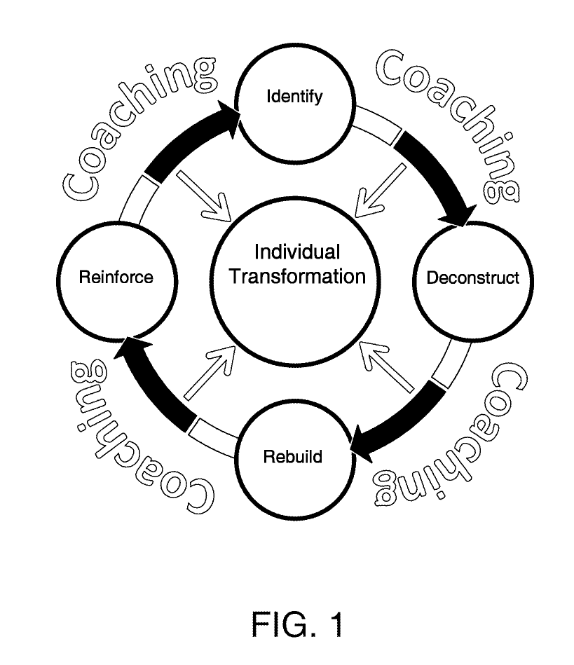

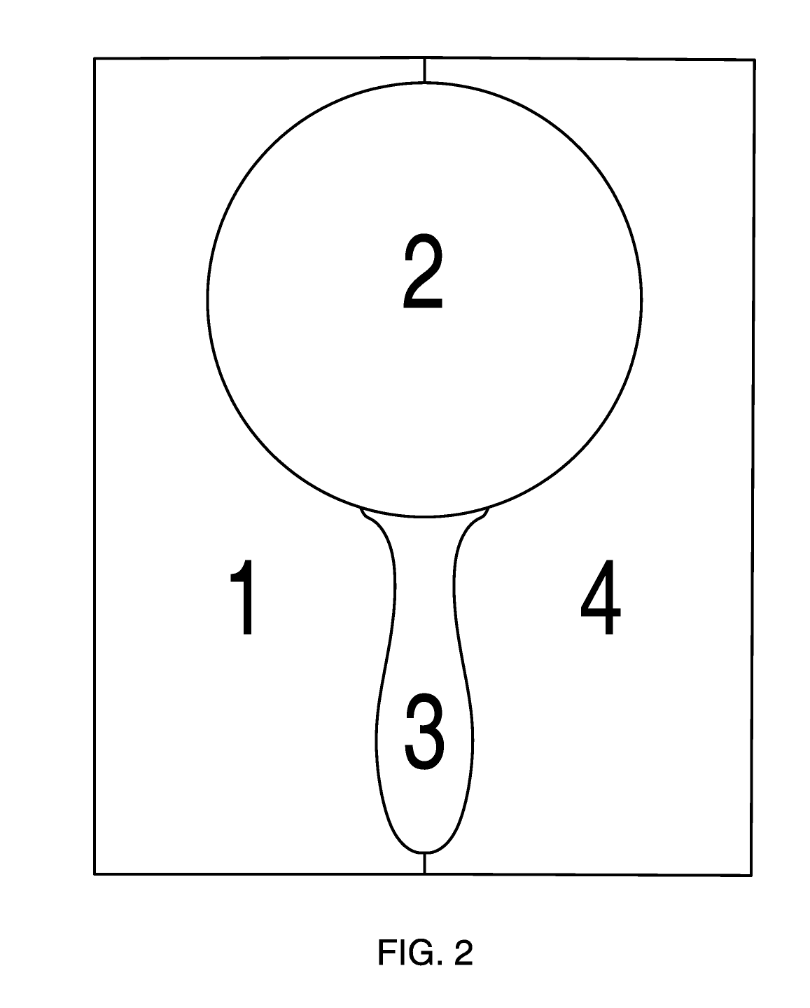

The power of the ABC process is in helping individuals identify their current state, break out of old ways and create a path forward in a 4 stage process; as depicted in FIG. 1: Identify, Deconstruct, Rebuild, and Reinforce. As shown in FIG. 2, the exemplary stained glass pattern used in this process also has 4 corresponding pieces for identifying each of the stages in the model which makes up a hand-held mirror. The mirror is a metaphor for inward exploration as a bridge to an envisioned future.

When constructing the leaded stained glass panel, using this model, three copies of the pattern are used:

Pattern number 1 is used to cut its individual pieces, with special lead pattern sheers (these have a well in one of the blades to capture the black line of the pattern accommodating for the lead). These pieces are used as templates for glass cutting.

Pattern number 2 is the template to arrange the cut glass pieces ensuring a perfect fit between the glass pieces and the size of the original panel. It also serves as the individual's private pattern to record their responses to guided questions asked by the coach along each stage of the model. This private space is for the individual only and is not shared with the coach or other participants. It is a personalized map that each individual creates towards their envisioned future.

Pattern number 3 is used to build the window. After the panel is built participant's private pattern can be placed behind the finished glass panel as a reminder of where the participants began, where they are today and where they are headed, and the tools they can employ to help them get there, using the four phases of the model guided by the coach through a series of reflective questions:
1. Stage One—Identify—Current State: Individuals are guided by the coach to identify the nature of the current situation they are facing. This is the coach's first opportunity to build an atmosphere of trust and a safe space for the individual. The coach's role is to provide guided exploration opportunities, tools and creative materials to allow freedom of expression without judgment. The individual's role is to visualize their current state, their starting point, and begin to take inventory of what has worked for them in the past and what no longer serves them. Individuals are asked to begin identifying the nature of the challenge they are facing and are asked to give it a name by writing it at the top of their private pattern template as well as jot down their perceptions of this challenge on pattern template number 1: “Identity.”

### Guided by the Coach, Individuals Refer Back to the Questions They Answered on the Pre-Session Survey:

What situation are you currently facing, that brings you to this retreat?

a. Opportunity

b. Loss

c. Change

In what stage of your situation are you in now?

a. Beginning

b. Meantime

c. Near the end

What is your current reaction to this situation?

a. Acceptance

b. Fear

c. Sadness

d. Anger

e. Withdrawal

f. Denial

### During This Stage the Coach Provides Further Guidance Through a Series of Inquiry Questions:

What are the things that have worked for you in the past when faced with a similar type of challenge (loss, change or opportunity)?
When was the last time you felt confident in yourself without fear?
When was the last time you felt most fulfilled?
2. Stage Two—Deconstruct—Old Patterns: Participants are asked to think about their reactions, actions or inactions that affect their present and may impact their future. At the point, individuals begin a journey of inward exploration that aims to break down old habits, one piece at a time, through self-reflection. This is also a chance to baseline the challenge or opportunity with continued guidance from the coach. Individuals are then asked to reflect on their past behavior, when faced with change, and their outcomes and write them on their private pattern template piece number 2: “Deconstruct.” They then begin to cut the pattern pieces from pattern template number 1.

### Guided by the Coach, Individuals Refer Back to the Questions They Answered on the Pre-Session Survey:

What reaction has come naturally in the past when faced with a similar situation?
What is your first course of action?

a. Plan

b. Fix

c. Run

d. Blame

e. Stand still

How can things be better for you?

### During This Stage the Coach Provides Further Guidance Through a Series of Inquiry Questions:

If you can go back and revisit your initial reaction to the situation what would it be in hindsight?
How can you reconcile your initial reaction with your desired one, if you feel you need to?
Is it necessary and why?
3. Stage Three—Rebuild—New Possibilities—Individuals are then asked to envision what a new or different desired state looks like for them. In a single word or short phrase, individuals write down their answer on their private pattern template piece number 3: “Rebuild.”
At this point individuals have identified old ways of doing things and begin to experiment, practice and make new connections between the status quo and the envisioned future. During this stage, coaches provide ample guidance and time for imagery to develop, intuition to take flight and a new picture to emerge.

### Guided by the Coach, Individuals Refer Back to the Questions They Answered on the Pre-Session Survey:

What can you do differently?
What stands in your way?
What support do you need?

a. Family

b. Friend

c. Coach

d. Professional

### During This Stage the Coach Provides Further Guidance Through a Series of Inquiry Questions:

What is the expected outcome?
How will you get there, what activities need to happen?
What does it look like when you get there?
4. Stage Four—Reinforce—New Reality: Participants are asked to reflect on the skills learned during this journey and how these could be used to help them fortify their present state and support them in the future. They record their responses on the private pattern template piece number 4: “Reinforce.” Now that individuals are ready to experiment with new opportunities and new ways of doing things, they can begin the evaluation process by reflecting on what is working for them and what additional improvements need to be made along the way. Here the coach provides room for further reflection facilitated by inquiry of the journey and further guidance.
At this stage there are no pre-session survey questions to review as these are asked before the start of the session when reinforcement is not yet foreseen by the participant.
   During this Stage the Coach Provides Further Guidance Through a Series of Inquiry Questions:
   What new skills were learned during this journey?
   Is the process of identification, deconstruction, rebuilding and reinforcement useful to you? How so?
   Was the experience what you expected? Yes/no
   If the answer is no, how was it different?
   What are your major takeaways?

This four-step process emphasizes the importance of the coach in facilitating and encouraging individual's inward exploration through the creative process for transformative change. This model seeks to show individuals the power they can harness s from identifying, acknowledging and reflecting on their own experiences, feelings and emotions and getting in touch with the tools they can use to build upon and help them through the meantime, while exploring the possibilities of forging a better future.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

As used in the claims, the following terms have these meanings:

A “habit” is a person's regular and repeated pattern of reactions and responses to a specific situation or circumstance, including mental, emotional, physical and behavioral reactions and responses.

“Habit components” means the discrete reactions and responses that comprise a habit, such as acceptance, fear, sadness, anger, withdrawal, or denial.

“Life challenge” means a change or transition in a person's life, including a new or altered event, opportunity, activity, job, relationship, or status, as well as personal loss or disappointment.

What is claimed is:

1. An arts-based life coaching process, comprising four process stages, practiced by a coach with one or more participants, the process comprising:
(a) the coach providing each participant with multiple copies of a pattern template for making an artwork, wherein the pattern template defines multiple boundaries of multiple pattern pieces, which together form the pattern;
(b) the coach providing each participant with one or more artwork materials, wherein the pattern template and the pattern pieces can be applied to the artwork materials to create corresponding material pieces that can be joined to form the artwork;
(c) the coach guiding each participant through a stage one identification process, wherein the participant identifies a life challenge that the participant is facing and records the participant's perceptions of the life challenge, and responses of the participant to questions posed by the coach regarding the life challenge, on a second copy of the pattern template, within the boundaries of a first pattern piece;
(d) the coach guiding each participant through a stage two deconstruction process, wherein the participant reflects upon and deconstructs obstructing habits of the participant relating to the life challenge, and wherein the participant breaks down the obstructing habits into multiple habit components, and wherein the participant records the participant's reflections on the obstructing habits and on the habit components, as the obstructing habits and the habit components relate to the life challenge, and responses of the participant to questions posed by the coach regarding the obstructing habits and the habit components, on the second copy of the pattern template, within the boundaries of a second pattern piece;
(e) each participant completing the stage two deconstruction process by performing stage two actions of cutting out of the pattern pieces from a first copy of the pattern template and applying the pattern pieces to the artwork material to create the corresponding material pieces, wherein the coach guides the participant to understand the stage two actions of cutting out the pattern pieces and creating the corresponding material pieces as an artistic expression of the participant's deconstruction of the obstructing habits;
(f) the coach guiding each participant through a stage three rebuilding process, wherein the participant envisions a desired outcome of the life challenge, based on reformed habits of the participant, and a path forward toward the desired outcome, and wherein the participant records the participant's vision of the desired outcome and the path forward toward the desired outcome, and responses of the participant to questions posed by the coach regarding the desired outcome, on the second copy of the pattern template, within the boundaries of a third pattern piece.
(g) each participant completing the stage three rebuilding process by performing the stage three actions of assembling and fitting together the corresponding material pieces on the second copy of the pattern template, wherein the coach guides the participant to understand the stage three actions as an artistic expression of the participant's desired outcome;
(h) the coach guiding each participant through a stage four reinforcing process, wherein the participant reflects upon and fortifies the participant's reformed habits and progress of the participant toward the desired outcome of the participant's life challenge, and wherein the participant records the participant's reflections upon participant's reformed habits and progress toward the desired outcome of the participant's life challenge and responses of the participant to questions posed by the coach regarding the participant's reformed habits and the participant's progress toward the desired outcome, on the second copy of the pattern template, within the boundaries of a fourth pattern piece; and
(i) the participant completing the stage four reinforcing process by performing the stage four actions of permanently joining together the corresponding material pieces on a third copy of the pattern template so as to create the artwork in a finished state, and then superimposing the artwork in the finished state over the second copy of the pattern template, wherein the coach guides the participant to understand the stage four actions as an artistic expression of the participant's reformed habits and progress toward the desired outcome of the participant's life challenge.

2. The arts-based life coaching process of claim 1, wherein, prior to step (c), each participant completes a survey and provides survey responses to questions regarding current status, situation, emotions and state of mind of the participant, and wherein the survey responses are used by the coach in guiding the participant through each process stage.

3. The arts-based life coaching process of claim 2, wherein the survey responses of each participant are used by the coach to formulate questions posed by the coach to each participant during one or more of the process stages.

4. The arts-based life coaching process of claim 1, wherein the second copy of the pattern template is a private space for each participant and is not shared with the coach or within other participants.

5. The arts-based life coaching process of claim 2, wherein the second copy of the pattern template is a private space for each participant and is not shared with the coach or within other participants.

6. The arts-based life coaching process of claim 3, wherein the second copy of the pattern template is a private space for each participant and is not shared with the coach or within other participants.
